(19) United States
(12) Patent Application Publication
(10) Pub. No.: US 2012/0096717 A1
(43) Pub. Date: Apr. 26, 2012

(54) Palm held electric razor

(76) Inventor: Jeffrey Todd Jetel, Los Gatos, CA (US)

(21) Appl. No.: 12/925,533

(22) Filed: Oct. 25, 2010

(51) Int. Cl. B26B 19/38; B26B 19/20

(52) U.S. Cl. 30/43.1; 30/526; 30/42

(57) ABSTRACT

There are three features of the palm held electric razor that are new in field of electric razors. By design, many components of existing razors can be incorporated into the design and manufacturing of the palm held electric razor. This will help keep the cost of manufacturing down, improve speed to market, and result in ecomonies of scale. However there are three features which are unique to this invention:
1. The unique shape of the razor body, which allows the razor to be held in the palm, allowing the user to easily run the razor over the head. This is especially critical when shaving the back of the head. No other razor is shaped like this and this unique feature is specifically for a razor designed to shave one's head.
2. The razor motor is oriented transversely to the horizontal, or long access. This orients the cutting blades parallel to the palm of the hand and makes it is easy to slide the blades over the skin of the head.
3. Variable thickness blade guards. The different thickness of the blade guards allow the user to control the length of the stubble left on the head. The ability to change the blade guards allows the user to choose from a close shave to the shave that leaves stubble of different lengths.

### BACKGROUND OF INVENTION

The genesis of the palm held electric razor is a result of the frustration found by men who shave their heads. Traditional electric razors are clumsy to use on one's head and lack the ability to control the length of stubble left on the head. Conventional twin-blade razors, while easier to use, also lack the ability to leave some stubble on the head. The palm held electric razor addresses these two concerns.

### SUMMARY OF THE INVENTION

The palm held electric razor is designed specifically for shaving one's head. It is designed to fit in the palm of one's hand for ease of use and to facilitate close, consistent contact with the head. In addition, the palm held electric razor includes blade guards that allow the user to control the length of stubble left on the head, from a close shave with no stubble, to stubble the length of 3.25 mm.

### DESCRIPTION OF THE VIEWS OF THE INVENTION

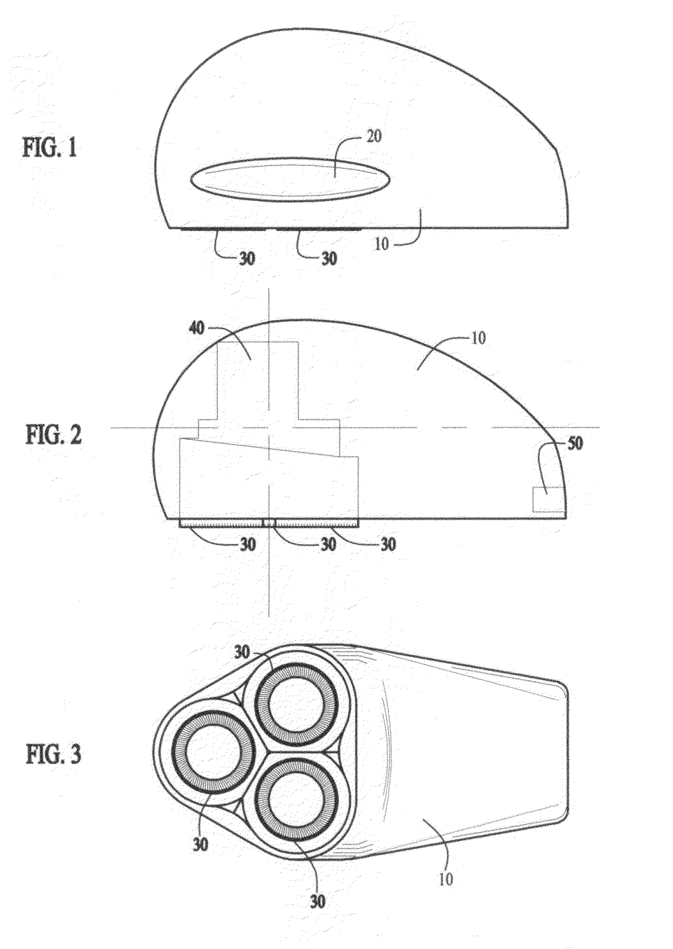

FIG. 1—This schematic shows the profile view of the razor and illustrates how the shape is designed to allow the razor to be held in the palm of one's hand.
Feature 10 is the body of the razor
Feature 20 illustrates a scalloped depression which helps the fingers and thumb grip the razor
Feature 30 illustrates how the blades and blade guards are oriented to contact the skin of the head

FIG. 2—This schematic shows a cut-away view of the razor
Feature 10 is the body of the razor
Feature 30 illustrates how the blades and blade guards are oriented to contact the skin of the head
Feature 40 is the electric motor. This view illustrates how the motor is oriented transversely to the horizontal, or long access. This is a key feature of the razor and allows the razor to be gripped in the palm of the hand while shaving the head.
Feature 50 is the plug recepticle

FIG. 3—This is the bottom view of the razor
Feature 10 is the body of the razor
Feature 30 illustrates how the blades and blade guards are oriented to contact the skin of the head

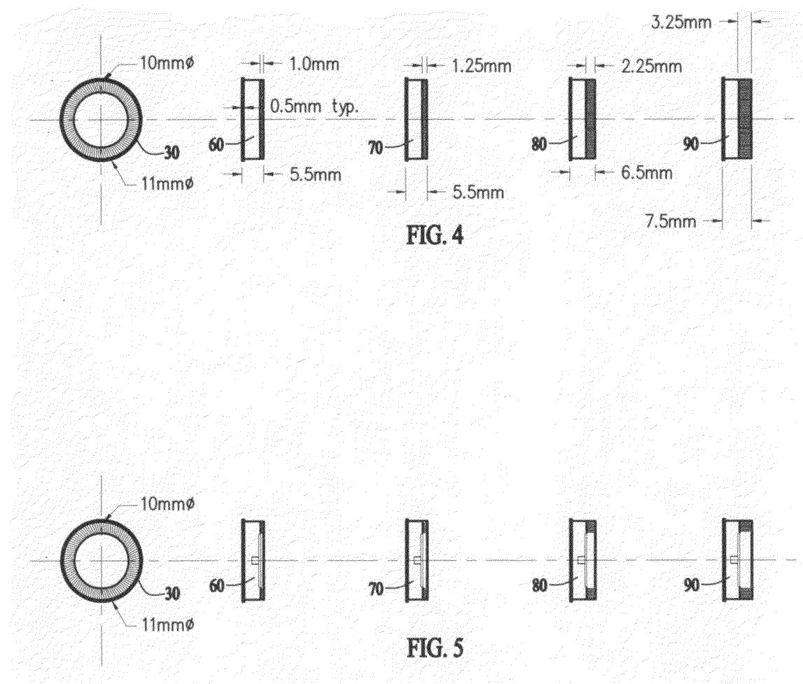

FIG. 4—This shows the different length blade guards.
Feature 30 is a view illustrating the diameter of the blade guard and offers a direct view of the the grill of the blade guard. The grill is what prevents the blades from coming in direct contact with the skin of the head.
Feature 60 shows a blade guard where the grill has a thickness of 1.0 mm. This guard would produce stubble the length of 1.0 mm.
Feature 70 shows a blade guard where the grill has a thickness of 1.25 mm. This guard would produce stubble of a length of 1.25 mm.
Feature 80 shows a blade guard where the grill has a thickness of 2.25 mm. This guard would produce stubble of a length of 2.25 mm.
Feature 90 shows a blade guard where the grill has a thickness of 3.25 mm. This guard would produce stubble of a length of 3.25 mm.

FIG. 5—This is a cut-away view of the blade guards. This view illustrates the thickness of blade guards in a cut-away view.
Feature 30 is a view illustrating the diameter of the blade guard and offers a direct view of the the grill of the blade guard. The grill is what prevents the blades from coming in direct contact with the skin of the head.
Feature 60 shows a blade guard where the grill has a thickness of 1.0 mm. This guard would produce stubble the length of 1.0 mm.
Feature 70 shows a blade guard where the grill has a thickness of 1.25 mm. This guard would produce stubble of a length of 1.25 mm.
Feature 80 shows a blade guard where the grill has a thickness of 2.25 mm. This guard would produce stubble of a length of 2.25 mm.
Feature 90 shows a blade guard where the grill has a thickness of 3.25 mm. This guard would produce stubble of a length of 3.25 mm.

### DETAILED DESCRIPTION OF THE INVENTION

The palm held electric razor is designed specifically for shaving one's head. It is designed to fit in the palm of one's hand for ease of use and to facilitate close, consistent contact with the head. In addition, the palm held electric razor includes blade guards that allow the user to control the length of stubble left on the head, from a close shave with no stubble, to stubble the length of 3.25 mm. The key features of the palm held electric razor are the following:

1. The unique shape of the razor body, which allows the razor to be held in the palm, allowing the user to easily run the razor over the head. This is especially critical when shaving the back of the head.

2. The razor motor is oriented transversely to the horizontal, or long access. This orients the cutting blades parallel to the palm of the hand and makes it is easy to slide the blades over the skin of the head.

3. Variable thickness blade guards. The different thickness of the blade guards allow the user to control the length of the stubble left on the head. The ability to change the blade guards allows the user to choose from a close shave to the shave that leaves stubble of different lengths.

1. There are three unique claims for the palm held electric razor:
1. The unique shape of the razor body, which allows the razor to be held in the palm, allowing the user to easily run the razor over the head. This is especially critical when shaving the back of the head. No other razor is shaped like this and this unique feature is specifically for a razor designed to shave one's head.
2. The razor motor is oriented transversely to the horizontal, or long access. This orients the cutting blades parallel to the palm of the hand and makes it is easy to slide the blades over the skin of the head.
3. Variable thickness blade guards. The different thickness of the blade guards allow the user to control the length of the stubble left on the head. The ability to change the blade guards allows the user to choose from a close shave to the shave that leaves stubble of different lengths.
